(19) United States
(12) Patent Application Publication
(10) Pub. No.: US 2010/0018600 A1
(43) Pub. Date: Jan. 28, 2010

(54) HIGH TEMPERATURE-RESISTANT HOSE

(76) Inventors: Michael L. Crouse, Lexington, TN (US); Kenneth Scott Jackson, Henderson County, TN (US)

Correspondence Address: MARSHALL & MELHORN, LLC, FOUR SEAGATE - EIGHTH FLOOR, TOLEDO, OH, 43604, US

(21) Appl. No.: 12/179,697

(22) Filed: Jul. 25, 2008

(51) Int. Cl. F16L 11/04

(52) U.S. Cl. 138/126; 138/137; 428/36.91

(57) ABSTRACT

An automotive vehicle vacuum brake hose that resists degradation when exposed to elevated temperatures up to about 175° C. for prolonged periods of time, the automotive vehicle vacuum brake hose comprising; an inner tubular member having an elastomeric matrix selected from the group consisting of acrylic elastomer and ethylene-vinyl acetate copolymer, and a protective cover around the inner tubular member. Preferably, the high temperature-resistant vacuum brake hose includes a reinforcement member around the inner tubular member and a protective cover around the reinforcement member.

### BACKGROUND OF THE INVENTION

1. Field of the Invention

The present invention relates to hoses, particularly automotive hoses that can withstand high temperatures such as found in turbocharged engines. In particular, the present invention is related to high temperature-resistant automotive vacuum brake hoses capable of withstanding temperatures up to about 175° C. for prolonged periods of time.

2. Description of the Prior Art

Conventional automotive hoses are manufactured from elastomeric materials, which provide certain desired characteristics. For example, automotive hoses must have sufficient flexibility in order to meet spatial requirements of the compartment in which the hoses are employed. Furthermore, the hoses must possess stability against hydrocarbon fluids, have a high degree of impermeability with respect to hydrocarbon fluids, have good resistance to extreme heat and cold, and must exhibit abrasion resistance in order to prevent physical degradation from road and environmental hazards. Certain automotive hoses may be employed to transport hydrocarbon fuels in connection with an internal combustion engine. In such applications, the automotive hose must exhibit characteristics which prevent or drastically reduce the release of not only the hydrocarbon fuel into the atmosphere, but also prevent or reduce combustion by-products such as nitrous oxides and sulfur oxides to the atmosphere. Other automotive hoses such as air conditioner hoses must be capable of preventing the permeation or escape of gaseous components into the atmosphere.

In recent years, government regulations for controlling automobile emissions into the atmosphere have become steadily tightened thereby placing an ever increasing burden on the automobile manufacturers to provide improved materials for the manufacture of automotive hoses. In complying with government requirements for reduced emissions, manufacturers of automotive hoses have found it necessary to incorporate multiple polymeric entities into the materials used to manufacture such hoses. However, attempts to improve one characteristic of a rubber material by incorporating another rubber material therein may have a deleterious effect on another characteristic of the resulting hose. For example, nitrile rubber hoses are known to be resistant to the permeation of fuel oil; however, attempts to enhance the fuel oil permeation characteristics of nitrile hoses by increasing the content of α, β-ethylenic unsaturation of the nitrile rubber dramatically reduces the cold resistance of the hose. Furthermore, nitrile/vinyl chloride hoses can be made to have improved resistance to fuel oil permeation by increasing the content of polyvinyl chloride in the nitrile/vinyl chloride polyblend, but here again, the cold resistance of the hose is reduced to an unacceptable level. Accordingly, choosing the right material or combination of materials to be used in the construction of automotive hoses for a particular use has become more and more difficult because various hoses are now required to exhibit specified characteristics tailored to meet the designated use requirements of the hose. Not only does the polymeric components of a polymeric blend affect the characteristics of the polymeric blend, but the presence or absene of any of the various additives normally present in the polymeric blend may be a critical factor in determining the effectiveness or ineffectiveness of a particular characteristic of a hose. For example, U.S. Publication 2007/0190278 discloses a heat-resistant air hose including a vacuum brake hose for a diesel engine. The hose is described as having an inner layer (A) and an outer layer (b). Inner layer (A) is an alloy material formed by mixing ethylene acrylic rubber and a fluororubber. The alloy material specifically excludes the presence of an acid receiver such as metal oxides (, i.e., zinc oxide and calcium oxide), in the alloy. The acid receiver apparently becomes dissolved by exhaust gases leading to cracks in the alloy material. The heat-resistant hose includes an outer layer composed specifically of a non-peroxide-crosslinkable ethylene-acrylic rubber and a non-halogen flame retardant. Apparently, a peroxide-crosslinkable ethylene-acrylic rubber coupled with a halogen flame retardant leads to the deterioration of physical properties of the hose. Outer layer (B) is a non-peroxide-crosslinkable ethylene-acrylic rubber wherein a non-halogen flame retardant is an essential component.

U.S. Pat. No. 4,759,388 discloses a hose comprising inner and outer tubes of an acrylic rubber. The acrylic rubber may be acrylic acid lower alkyl ester alone, or the ester is a main component polymerized with copolymerizable monomer under the presence of a crosslinking agent. The acrylic rubber may be a copolymer comprising acrylic acid lower alkyl ester as a main component and ethylene and vinyl acetate as copolymer components. The crosslinking agent may be an acrylic acid derivative having one of carboxyl group, epoxy group and chlorine atoms, or a methacrylic acid derivative.

European Patent No. 0370361 discloses soft, elastic polymer mixtures based on crosslinked, particulate alkyl acrylate rubbers and hydrolyzed ethylene vinyl acetate copolymers.

U.S. Pat. No. 5,492,971 discloses a curable ethylene copolymer blend composition which is a blend of an ethylene dipolymer, an ionomer of an ethylene unsaturated acid copolymer, and a peroxide curing agent. The ethylene dipolymer may be ethylene vinyl acetate. The ionomer may be ethylene/methyl acrylate/ethyl hydrogen maleate.

Paper No. 187 presented at the meeting of the Rubber Division, American Chemical Society, Orlando, Fla., Sep. 21 through 24, 1999, discloses the use of ethylene vinyl acetate in compounds suitable for use in automotive hoses. The ethylene vinyl acetate compounds disclosed utilize enhanced viscosity ethylene vinyl acetate that has been partially crosslinked via peroxide or radiation. The ethylene vinyl acetate compounds therein are shown to have superior high temperature property retention as compared with compounds of chlorosulfonated polyethylene or ethylene/methyl acrylate terpolymer.

In certain automotive applications such as in a turbo charged engine which generates high underhood temperatures exceeding 150° C., there is a pressing need for elastomeric hoses that can endure such elevated temperatures for prolonged periods of time. While elastomeric materials have been widely used in the manufacture of automotive hoses, more recent specialized applications requiring high temperatures greater than about 150° C. are beyond the temperature capabilities of most elastomeric materials.

In the present invention, vacuum brake hoses, particularly, vacuum brake hoses are intended to be employed in turbo charged engines where temperatures of 175° C. or higher are routinely encountered for long periods of time. Such vacuum brake hoses also must be capable of resisting degradation upon continued exposure to such extremely high temperatures while maintaining a good balance of properties such as compression set, flex resistance, tensile and elongation, low temperature flexibility and oil resistance compared to other hoses employed to provide a different task. In view of the mandated requirements imposed upon the automotive industry, the manufacturers of automotive hoses find it necessary to constantly come up with newer and better materials and combinations of materials to meet the mandated requirements while maintaining manufacturing costs at an acceptable level to meet these rising needs.

Accordingly, it is an object of the present invention to provide a vacuum brake hose for use in a automotive vehicle powered by a turbocharged engine wherein the vacuum brake hose exhibits superior high temperature resistant characteristics when exposed to temperatures greater than about 175° C. or higher for prolonged periods of time, while maintaining good balance of physical properties such as compression set, flex resistance, tensile and elongation, low temperature flexibility and oil resistance, when compared to conventional vacuum brake hoses.

### SUMMARY OF THE INVENTION

It has now been found that hoses exhibiting high temperature resistant characteristics when exposed to temperatures of about 175° C. and higher for prolonged periods of time can be constructed of certain elastomeric materials selected from the group consisting of acrylic elastomers and ethylene-vinyl acetate (EVM) copolymers. The high temperature-resistant hoses of the present invention not only provide high temperature resistance up to about 175° C. and higher for prolonged periods of time, but they also retain a good balance of physical properties such as compression set, flex resistance, tensile and elongation, low temperature flexibility and oil resistance after exposure to such high temperatures. Furthermore, the high temperature-resistant hoses of the present invention are manufactured without requiring blends of other various polymeric materials, thus leading to reduced manufacturing costs.

In a first embodiment of the invention, the High temperature-resistant hose includes (a) an inner tubular structure having, as a matrix, an elastomeric material selected from the group consisting of acrylic elastomers and ethylene-vinyl acetate copolymers; and (b) a protective cover around the inner tubular structure.

In a preferred embodiment of the invention, the high temperature-resistant hose includes (a) an inner tubular structure having, as a matrix, an elastomeric material selected from the group consisting of acrylic elastomers and ethylene-vinyl acetate copolymers; (b) a reinforcement member around the inner tubular structure; and (c) a protective cover around the reinforcement member.

The high temperature-resistant hoses of the invention are well suited for applications requiring continuous exposure to hot aliphatic hydrocarbon fluids such as automotive lubricants and hydraulic fluids. In particular, the high temperature resistant hoses are effective in turbocharged automotive vehicles where temperatures typically reach up to up to 175° C. and higher for prolonged periods of time.

### BRIEF DESCRIPTION OF THE DRAWINGS

FIG. 1 is a perspective view of a first embodiment of the high temperature-resistant hose according to the present invention; and

FIG. 2 is a perspective view of a second embodiment of the high temperature-resistant hose accordance with the present invention.

### DETAILED DESCRIPTION OF THE INVENTION

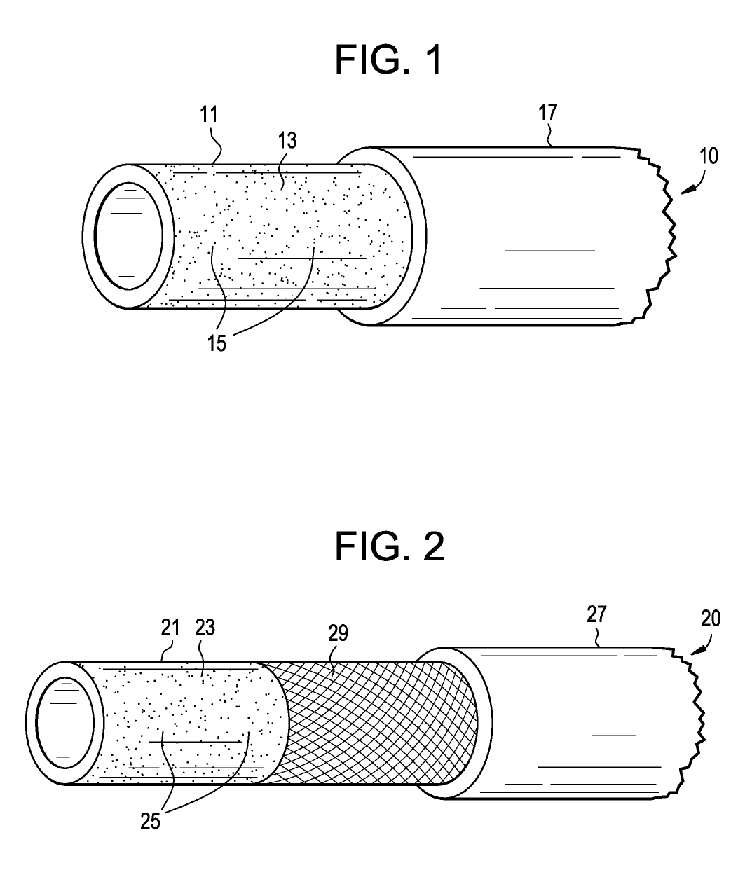

With respect to the Figures provided to exemplify the present invention, FIG. 1 illustrates a first embodiment of the invention wherein the automotive vehicle vacuum brake hose 10 includes an elastomeric tubular member 11 having an elastomer matrix 13 including a plurality of additives 15 dispersed therein. The automotive vehicle vacuum brake hose 11 further includes a protective cover 17 around the elastomeric tubular structure 11.

FIG. 2 illustrates a second embodiment of the invention wherein the automotive vehicle vacuum brake hose 20 includes an elastomeric tubular member 21 having an elastomer matrix 23 including a plurality of additives 25 dispersed therein. In the embodiment of FIG. 2, the automotive vehicle vacuum brake hose 20 includes a protective cover 27 and a reinforcement member 29 disposed between the elastomeric tubular member 21 and the protective cover 27.

In accordance with the present invention, there is provided a high temperature-resistant vacuum brake hose comprising an elastomeric tubular member having, as a matrix, an elastomeric material selected from the group consisting of acrylic elastomers and ethylene-vinyl acetate (EVA) copolymers. In addition to the elastomeric tubular member, the vacuum brake hose may include a reinforcing member around the elastomeric tubular member to provide reinforcement and strength to the hose, and a protective cover around the reinforcing member to protect the hose from environmental hazards.

The elastomeric tubular member of the high temperature-resistant vacuum brake hose of the present invention is formed from an elastomeric material, which provides an elastomer matrix having dispersed therein a plurality of specified additives. The elastomeric tubular member containing such additives is effective in withstanding the extraordinarily high temperatures associated with the high performance turbo charged engines currently being manufactured.

The elastomeric materials useful in the present invention to providing the elastomer matrix of the present invention include, but are not limited to acrylic elastomers and ethylene-vinyl acetate copolymers (EVM). Preferably the elastomeric material is an acrylic elastomer such as ethylene-acrylate (AEM) and polyacrylate (ACM). VAMAC G, an ethylene-acrylic elastomer available from du Pont has been found particularly effective in providing the high temperature-resistant properties of the vacuum brake hoses of the present invention while allowing such hoses to maintain a good balance of physical properties such as compression set, flex resistance, tensile and elongation, low temperature flexibility, and oil resistance.

The reinforcement member is formed of a suitable reinforcement material, which may include organic or inorganic fibers or metal wires such as brass-plated steel wires. Typically, the reinforcement layer is a single layer of reinforcement material. The reinforcement material is preferably an organic fiber material, such as nylon, polyester, aramid, cotton or rayon. Preferably, the reinforcement material is an aromatic polyamide such as Kevlar or Nomex, both of which are manufactured by DuPont. The reinforcement member may be constructed of any suitable type such as braid, spiral, knit or wrapped, but in the embodiment shown in the Figure, is of a braid construction. The reinforcement member may further be treated with an RFL-type treatment to promote adhesion between the reinforcement and the inner and outer layers. However, a more preferred method for adhering the various layers together is to apply a sufficient amount of an effective adhesive between the various layers. Such adhesives for this purpose are known in the art.

An outer protective cover preferably surrounds the reinforcement member. The protective cover can be any conventional material that effectively protects the vacuum brake hose from environmental hazards. Typically, the outer protective cover layer is a synthetic elastomer selected from the group consisting of styrene-butadiene rubber; butadiene-nitrile rubber such as butadiene-acrylonitrile rubber; chlorinated rubber; chlorosulfonated polyethylene; vinylethylene-acrylic rubber; acrylic rubber; epichlorohydrin rubber such as Hydrin 200, a copolymer of epichlorohydrin and ethylene oxide available from DuPont, ECO; polychloroprene rubber; polyvinyl chloride; ethylene-propylene copolymers; ethylene-propylene-diene terpolymers; ultra high molecular weight polyethylene; high density polyethylene; and blends thereof. Preferably, the protective cover is formed from ethylene-propylene-diene monomer EPDM) or chlorinated polyethylene (CPE); or the protective cover may be formed from the same elastomeric material as the elastomer matrix member of the present invention.

In addition to the acrylic rubber or the ethylene-vinyl acetate copolymer, the elastomeric matrix of the automotive vehicle vacuum brake hose typically contains certain additives including one or more reinforcing agents, one or more plasticizers, one or more processing aids, one or more antioxidants, one or more antidegradents, one or more stabilizers and one or more vulcanizing agents. While it is preferable to include such additives in the acrylic rubber or the ethylene-vinyl acetate copolymer inner layer, such additives may be added to the cover layer as well. Various other conventional additives such as fillers, pigments, accelerators, antiozonants, activators, initiators, waxes, pre-vulcanization inhibitors, extender oils and the like may be added to either or both of the inner member and/or the cover, provided that such other additives do not adversely affect the desired purpose of the present invention.

Representative of the various additives found to be effective in providing the desired characteristics of the high temperature-resistant vacuum brake hose of the present invention include carbon black as a reinforcing agent, butyl triglycerol adipate as a plasticizer, stearic acid and organic phosphate esters as processing aids, diphenylamine as an antidegradent, oxalyl bis (benzylidenehydrazide as a stabilizer, and hexamethylene diamine carbamate and diortho tolylguanidine as vulcanizing agents.

The carbon black reinforcing agent is typically added to the elastomer matrix in amounts ranging from about 35 to 50% by weight of total elastomer matrix. Typical carbon blacks that are used include N10, N330, N332, N472, N550, N630, N642, N650, N762, N770, N907, N908, N990, and N991.

The butyl triglycerol adipate plasticizer is typically added to the elastomer matrix in amounts ranging from about 3 to 7% by weight of the total elastomer matrix.

The stearic acid process aid is typically added in amounts of about 0.2 to 1% by weight of the total elastomer matrix, and the organic phosphate ester process aid is typically added in amounts of about 0.1 to 0.75% by weight of the total elastomer matrix.

The diphenylamine antioxidant is typically added in amounts of about 0.25 to 2% by weight of the total elastomer matrix.

The 1 -octanedecaneamine antidegradent is typically added in amounts of about 0.2 to 1% by weight of the total elastomer matrix.

The oxalyl bis(benzylidenehydrazide) stabilizer includes is typically added in amounts of about 0.1 to 0.75% by weight of the total elastomer matrix.

The multilayer hoses of the present invention are either unvulcanized or vulcanized Preferably, the high temperature-resistant vacuum brake hose of the present invention is vulcanized using any of the art established vulcanizing agents such as peroxides, polyols, polyamines, etc. The peroxide vulcanizing agent includes, for example, dicumyl peroxide, 2-5-dimethyl-2,5-di(t-butylperoxy) hexyne-3, etc. The polyol vulcanizing agent includes, e.g., hexafluoroisopropylidene-bis (4-hydroxyphenyl-hydroquinone, isopropylidene-bis (4-hydroxyphenyl), and the like. The polyamine vulcanizing agent includes, e.g., hexamethylenediamine carbamate, alicyclic diamine carbamate, diortho tolylguanidine, etc. The amount of vulcanizing agents employed is generally that which is customarily used in the art. Typically, about 0.1 to 10%, preferably about 0.5 to 2% vulcanizing agent is employed depending upon the vulcanizing agent employed.

The other additives which may be used provided that they do not adversely affect the desirable properties of the high temperature-resistant vacuum brake hose include silica, talc, clay, calcium carbonate, crosslinking co-agents, accelerators and the I The high temperature-resistant hoses of the present invention are formed by known methods such as extruding the various layers using simultaneous, extrusion, tandum extrusion, or coextrusion. Typically, the high temperature-resistant hoses of the present invention are produced by separate or tandum extrusion for versatility and economic reasons.

A typical formulation (PHR) used in providing the inner tubular member of a high temperature-resistant vacuum brake hose of the present invention is as follows:

| Component | PHR |
|---|---|
| Ethylene-acrylic elastomer¹ | 100 |
| Carbon black (reinforcing agent) | 95 |
| Butyl triglycol adipate (plasticizer) | 10 |
| Stearic acid (process aid) | 2 |
| Diphenylamine (antioxidant) | 2 |
| 1-Octanedecanamine (antidegradent) | 2 |
| Organic phosphate ester (process aid) | 1 |
| Oxylyl bis (benzylidenehydrazide (stabilizer) | 1 |
| Hexamethylene diamine carbonate | 2.4 |
| (vulcanizing agent) | |
| Diortho tolylguanidine (vulcanizing agent) | 4 |

¹VAMAC G available from du Pont

The above formulation is only one representation of an inner tubular member of the composition of the present invention. Other formulations, in the desired amounts, using various elastomeric materials and additives suggested in the specification or those elastomeric materials apparent to those skilled in the art may be employed in forming the inner tubular structure, the outer cover or any other tubular layer employed to manufacture the high temperature-resistant hose of the invention.

Having described the invention in detail and by reference to preferred embodiments thereof, it will be apparent to those skilled in the art that modifications and variations are possible without departing from the scope of the invention as defined in the appended claims.

What is claimed is:

1. A high temperature-resistant hose exhibiting improved compression set, flex: resistance, tensile and elongation, and oil resistance at temperatures up to about 175° C. for prolonged periods of time, as well as low temperature flexibility, when compared to conventional vacuum brake hoses, said automotive vacuum brake hose comprising:
an inner tubular member having an elastomeric matrix selected from the group consisting of acrylic elastomer and ethylene-vinyl acetate copolymer: and
a protective cover around said inner tubular member.

2. The high temperature-resistant hose of claim 1 wherein said high temperature-resistant hose is a high temperature-resistant vacuum brake hose.

3. The high temperature-resistant hose of claim 1 wherein said elastomeric matrix is formed from one of a polyacrylic elastomer and an ethylene-acrylic elastomer.

4. The high temperature-resistant hose of claim 1 wherein said elastomeric matrix is formed of an ethylene-vinyl acetate copolymer.

5. The high temperature-resistant hose of claim 1 wherein said elastomeric matrix has, dispersed therein, a plurality of additives selected from the group consisting of carbon black, butyl triglycol adipate, stearic acid, diphenylamine, 1-octanedecandamine, organic phosphate ester, bis (benzylidenehydrazide, hexamethylene diamine carbamate and diortho tolylguanidine.

6. The high temperature-resistant hose of claim 5 consisting essentially of about 10 to 50% by weight of said elastomer matrix and about 90 to 50% by weight of said plurality of additives.

7. The high temperature-resistant hose of claim 1 further comprising a reinforcing member, said reinforcement member being disposed between said inner tubular member and said protective cover wherein said reinforcement member is formed of natural or synthetic fibers selected from the group consisting of cotton, polyester, nylon, rayon and aramid; or metal wire.

8. The high temperature-resistant hose of claim 1 wherein said protective cover layer is formed of a synthetic elastomer selected from the group consisting of acrylic elastomer, ethylene-vinyl acetate copolymer, ethylene-propylene-diene monomer and chlorinated polyethylene.

9. The high temperature-resistant hose of claim 1, wherein said inner tubular member consists essentially of:
about 10 to 50% by weight ethylene-acrylic elastomer;
about 35 to 50% by weight carbon black;
about 3 to 7% by weight butyl triglycol adipate;
about 0.2 to 1% by weight stearic acid;
about 0.25 to 2% by weight diphenylamine;
about 0.2 to 1% by weight 1
about 0.1 to 0.75% by weight organic phosphate ester;
about 0.1 to 0.75% by weight oxalyl bis (benzylidenehydrazide);
about 0.5 to 2% by weight hexamethylene diamine carbamate; and
about 0.5 to 2.5% by weight diortho tolylguanidine.

10. The high temperature-resistant hose of claim 2 wherein said high temperature-resistant vacuum brake hose is a vulcanized high temperature vacuum brake hose.

11. In a vacuum brake hose exposed to hot aliphatic hydrocarbon fluid for prolonged periods of time, the improvement wherein said vacuum brake hose is a high temperature-resistant vacuum brake hose, said high temperature-resistant hose comprising:
an inner tubular member having an elastomeric matrix selected from the group consisting of acrylic elastomer and ethylene-vinyl acetate copolymer: and
a protective cover around said inner tubular member,
wherein said high temperature-resistant vacuum brake hose is resistant to temperatures up to 175° C. for prolonged periods of time and exhibits improved compression set, flex resistance, tensile and elongation, oil resistance, degradation resistance, and improved low temperature flexibility when compared to conventional vacuum brake hoses.

12. The vacuum brake hose of claim 11 wherein said vacuum brake hose is employed in a turbocharged automotive vehicle.

13. The vacuum brake hose of claim 11 wherein said elastomeric matrix is formed from one of a polyacrylic elastomer and an ethylene-acrylic elastomer.

14. The vacuum brake hose of claim 11 wherein said elastomeric matrix is formed of an ethylene-vinyl acetate copolymer.

15. The vacuum brake hose of claim 11 wherein said elastomeric matrix has, dispersed therein, a plurality of additives selected from the group consisting of carbon black, butyl triglycol adipate, stearic acid, diphenylamine, 1-octanedecandamine, organic phosphate ester, bis (benzylidenehydrazide, hexamethylene diamine carbamate and diortho tolylguanidine.

16. The vacuum brake hose of claim 15 consisting essentially of about 10 to 50% by weight of said elastomer matrix and about 90 to 50% by weight of said plurality of additives.

17. The vacuum brake hose of claim 11 further comprising a reinforcement member disposed between said inner tubular structure wherein said reinforcement member is formed of natural or synthetic fibers selected from the group consisting of cotton, polyester, nylon, rayon and aramid; or metal wire.

18. The vacuum brake hose of claim 11 wherein said protective cover layer is formed of a synthetic elastomer selected from the group consisting of acrylic elastomer, ethylene-vinyl acetate copolymer, ethylene-propylene-diene monomer and chlorinated polyethylene.

19. The vacuum brake hose of claim 11, wherein said inner tubular member consists essentially of:
about 10 to 50% by weight ethylene-acrylic elastomer;
about 35 to 50% by weight carbon black;
about 3 to 7% by weight butyl triglycol adipate;
about 0.2 to 1% by weight stearic acid;
about 0.25 to 2% by weight diphenylamine;
about 0.2 to 1% by weight 1
about 0.1 to 0.75% by weight organic phosphate ester;
about 0.1 to 0.75% by weight oxalyl bis (benzylidenehydrazide);
about 0.5 to 2% by weight hexamethylene diamine carbamate; and
about 0.5 to 2.5% by weight diortho tolylguanidine.

20. The vacuum brake hose of claim 11 wherein said high temperature-resistant vacuum brake hose is a vulcanized high temperature vacuum brake hose.
